(19) United States
(12) Patent Application Publication
(10) Pub. No.: US 2025/0026072 A1
(43) Pub. Date: Jan. 23, 2025

(54) METHOD OF MANUFACTURING A DECORATIVE PART DECORATED WITH A LICHTENBERG-FIGURE

(71) Applicant: JOYSONQUIN Automotive Systems GmbH, Rutesheim (DE)

(72) Inventors: Stefan BROMMER, Tamm (DE); Liesa GUNTHER, Pforzheim (DE)

(21) Appl. No.: 18/772,163

(22) Filed: Jul. 13, 2024

(30) Foreign Application Priority Data
Jul. 19, 2023 (DE) 102023119077.6

(51) Int. Cl. B29C 59/10; B27M 1/06

(52) U.S. Cl. CPC B29C 59/10; B27M 1/06

(57) ABSTRACT

Manufacturing of a decorative part by providing a decorative layer having a first, electrically conductive surface and a second surface; bringing electrodes into contact with the first surface; and applying an electrical voltage between the electrodes so that an electrical current flows between the electrodes and a pattern is burned into the first surface. In an embodiment, the decorative layer is bonded to a lamination layer before applying the electrical voltage to the second surface. In another embodiment, the decorative layer is bonded to a lamination layer after the application of the electrical voltage to the first surface; and after the bonding of the lamination layer, the material of the decorative layer is removed from the second surface. In another embodiment the decorative layer has a pattern generated by an electrical discharge on the first surface; and the first or the second surface is bonded to a lamination layer.

### FIELD OF THE INVENTION

The present invention relates to a method for manufacturing a decorative part decorated with a Lichtenberg-figure and to a decorative part which may be manufactured by this method.

### BACKGROUND OF THE INVENTION

Decorative elements with different decorative patterns, which are for example created via printing, are known in automotive engineering. However, for technical reasons, these patterns are not individual in most cases, but regular and are repeated from decorative element to decorative element. However, there is an interest in irregular, “naturally” grown decorative patterns that give the decorative element an individual character.

One method of creating irregular patterns on a surface is to burn a pattern into an electrically conductive surface using an electrical discharge. The resulting patterns are also known as Lichtenberg-figures after their discoverer, the natural scientist Lichtenberg.

Lichtenberg-figures may be created on wooden surfaces, for example. For this purpose, two or more electrodes are placed on the wood surface and an electrical voltage is applied. Before this step, the wood surface may be wetted with an electrolyte solution to increase conductivity. If the voltage is high enough, a current flows between the electrodes, which decomposes the underlying material by heat and discharge along its constantly changing path. This creates channel-shaped indentations in the treated surface. These indentations form irregular, tree-like branched patterns that are considered highly decorative. These patterns are naturally unique, so that no two Lichtenberg-figures are exactly alike.

In automotive engineering, decorative elements are used in particular for the decorative design of the interior. The decorative parts usually consist of a decorative layer and one or more additional layers bonded to the decorative layer, such as plastic carrier and cover layers. In the majority of cases, the decorative parts used in automotive engineering are narrow and long and have a large length-to-width ratio. This general format is favorable for the use of Lichtenberg-figures, as the patterns of the Lichtenberg-figures extend along the connecting line between the two electrodes and thus cover a narrow, elongated area.

However, one problem that stands in the way of using Lichtenberg-figures for decorative parts of this kind is that the decorative layers in question have to be as thin as possible. For example, wood veneers that are only a few millimeters thick are used for the decorative layer of a decorative element in automotive engineering. When burning in Lichtenberg-figures into such a thin decorative layer, the burned-in channels may penetrate the entire thickness of the decorative layer. This feeds into reduced stability of the decorative layer. In particular, there is the problem that the channel-shaped indentations of the Lichtenberg-figures, which were initially split, reunite. In the process, island-shaped areas of the decorative layer are separated, which therefore no longer have any mechanical cohesion with the rest of the decorative layer. This may be a hindrance during further processing of the decorative layer into a decorative part, as the island-shaped areas either fall out of the decorative layer during further processing of the decorative layer and thus impair the quality of the decorative surface or have to be held in place manually at great expense.

### SUMMARY OF THE INVENTION

It is the object of the present invention to provide a method for manufacturing decorative parts which may be used, for example, as decorative parts in automotive engineering. The decorative parts should have a thin decorative layer decorated with a Lichtenberg-figure. The method should be able to be carried out without unnecessary manual work and produce decorative surfaces of high quality.

This object is solved by a method for manufacturing a decorative part and a decorative part according to the embodiments.

The invention is based on the general idea of bonding a decorative layer, into which a Lichtenberg-figure is or is to be burned in, with a lamination layer. The lamination layer ensures the mechanical cohesion of the decorative layer. In particular, the lamination layer bonds island-shaped areas of the decorative layer, which may occur when burning in the Lichtenberg-figure, to the rest of the decorative layer. This enables a manufacturing process that guarantees a high-quality decorative surface without the need for time-consuming/complex manual work.

### Manufacturing Process

The invention provides two variants of a method for manufacturing a decorative part.

In a first variant, the invention relates to a method for manufacturing a decorative part comprising the steps of:

providing a decorative layer which has a first, electrically conductive surface and a second surface facing away from the first surface;

bringing two or more electrodes into contact with the first surface;

applying an electrical voltage between the electrodes so that an electrical current flows between the electrodes and a pattern is burned into the first surface.

The method according to the first variant is characterized in that

the decorative layer is bonded to a lamination layer before the electrical voltage is applied to the second surface.

With this variant of the method, it is possible to burn a pattern in the form of a Lichtenberg-figure of high quality into a decorative layer, even if the decorative layer is extremely thin. This is achieved by bonding the decorative layer to a lamination layer before applying the electrical voltage. The lamination layer gives the decorative layer the necessary mechanical stability and prevents island-shaped areas from falling out, which may form when the pattern is burned in.

In a second variant, the invention relates to a method for manufacturing a decorative part comprising the steps of:

providing a decorative layer which has a first, electrically conductive surface and a second surface facing away from the first surface;

bringing two or more electrodes into contact with the first surface; and

applying an electrical voltage between the electrodes so that an electrical current flows between the electrodes and a pattern is burned into the first surface.

The method according to the second variant is characterized in that,

the decorative layer has a predetermined minimum thickness;

the decorative layer is bonded to a lamination layer after the application of the voltage to the first surface; and

after the lamination layer has been bonded, the material of the decorative layer is removed from the second surface so that the thickness of the decorative layer is reduced to a predetermined maximum thickness.

With this variant of the method, it is possible to burn a pattern in the form of a Lichtenberg-figure of high quality into a decorative layer and at the same time obtain a decorative layer with the required thickness. This is achieved by first burning the pattern into a decorative layer with a predetermined minimum thickness. Preferably, the minimum thickness of the decorative layer is selected so that the burning in of the pattern does not result in any island-shaped areas that no longer have any mechanical cohesion with the rest of the decorative layer. The material of the decorative layer is then removed from the surface facing away from the pattern in order to obtain a decorative layer with the desired maximum thickness. As this process may result in island-shaped areas in the decorative layer that are no longer bonded to the rest of the decorative layer, the decorative layer is first bonded with a lamination layer, which gives the decorative layer the necessary mechanical stability and prevents the island-shaped areas from falling out.

Both variants of the method lead to a decorative part comprising a decorative layer decorated with a Lichtenberg-figure, wherein the decorative layer is bonded to a stabilizing lamination layer. The Lichtenberg-figure is the pattern generated by the electrical discharge on the first surface.

The decorative layer may be made of any material that is suitable for burning in Lichtenberg-figures. For example, the decorative layer may be made of plastic or wood, wherein wood is a particularly preferred material. Preferably, the decorative layer is a wood veneer, preferably a solid wood veneer.

The decorative layer has two opposite main surfaces, which are referred to as first and second surfaces in the context of the present invention. These main surfaces lie opposite each other and each face in opposite directions. The first surface is the main surface that is brought into contact with the electrodes and into which the pattern is consequently burned in. In the finished decorative part, the first surface preferably faces the viewer and thus defines the visible side of the decorative part. The second surface is preferably facing away from the viewer and thus defines the carrier side of the decorative part. However, it is also possible to burn the pattern into the decorative layer so deeply that it is also visible on the second surface. In this case, the decorative layer in the finished decorative part may also be arranged in such a way that the second surface faces the viewer and defines the visible side, while the first surface defines the carrier side.

The first and second surfaces are preferably, but not necessarily, rectangular. It is also possible for the surfaces to have different basic shapes. For example, the surfaces may be round, oval, kidney-shaped, trapezoidal or in the shape of a polygon.

The decorative layer is preferably plate-shaped. This means that the extent of the decorative layer is greater in the length and width direction than in the depth direction. In the context of the present invention, the depth direction is defined as the direction extending perpendicular to the first surface. The depth direction corresponds to the thickness of the decorative layer.

According to the first variant of the method, the decorative layer is preferably thin. Preferably, the decorative layer has a thickness of 100 mm or less, 50 mm or less, 20 mm or less, 10 mm or less, 5 mm or less, or 2 mm or less. The thinner the decorative layer, the lighter and more space-saving the decorative part may be. To ensure the mechanical stability of the decorative layer, the thickness of the decorative layer is preferably at least 0.1 mm or more, 0.5 mm or more, 1 mm or more, 2 mm or more, or 5 mm or more. For example, the decorative layer may have a thickness in the range of 0.1 mm to 100 mm, 0.5 mm to 50 mm, 1 mm to 20 mm, or 2 mm to 10 mm.

In the second variant of the method, a relatively thick decorative layer is processed first. In this variant, the decorative layer therefore has a predetermined minimum thickness. The minimum thickness of the decorative layer is selected so that no island-shaped areas are formed in the decorative layer during burning in of the pattern, which no longer have any mechanical cohesion with the rest of the decorative layer. It is possible to penetrate the thickness of the decorative layer in places through the burned-in pattern, provided that this does not result in any island-shaped areas that are completely separated from the rest of the decorative layer. Preferably, the thickness of the decorative layer is selected so that the burned-in pattern does not penetrate the entire thickness of the decorative layer, i.e. at any point on the decorative layer. Preferably, the decorative layer has a minimum thickness of at least 10 mm or more, 20 mm or more, 50 mm or more, 100 mm or more, or 200 mm or more. The maximum thickness of the decorative layer before burning in the pattern is of secondary importance. It should be limited in order to avoid having to remove an unnecessarily large amount of material. Preferably, the decorative layer should therefore have a thickness of 500 mm or less.

After the pattern has been burned in and bonded to the lamination layer, the thickness of the decorative layer in the second variant of the method is reduced to a predetermined maximum thickness by removing material. The maximum thickness may, for example, be selected so that the pattern burned into the first surface is also at least partially visible on the opposite second surface. Preferably, the decorative layer has a thickness of 100 mm or less, 50 mm or less, 20 mm or less, 10 mm or less, 5 mm or less, or 2 mm or less after the removal of material. To ensure the mechanical stability of the decorative layer, the thickness of the decorative layer after removal is preferably at least 0.1 mm or more, 0.5 mm or more, 1 mm or more, 2 mm or more, or 5 mm or more. For example, the decorative layer after removal may have a thickness in the range of 0.1 mm to 100 mm, 0.5 mm to 50 mm, 1 mm to 20 mm, or 2 mm to 10 mm.

The removal of material after bonding the lamination layer according to the second variant of the method may be carried out, for example, by grinding or planing the decorative layer from the second surface. Alternatively, the decorative layer may also be cut or sawn into two partial layers parallel to the first surface. The first partial layer bonded to the lamination layer then forms the decorative part. The partial layer separated from the first surface may be used for another stage of the method.

According to the invention, a lamination layer is bonded to the first or second surface of the decorative part. In the case of the first variant of the method, the lamination layer is bonded to the second surface before the pattern is burned into the first surface. According to the second variant of the method, the lamination layer is bonded to the first surface after the pattern has been burned into the first surface and before the material of the decorative layer is removed from the second surface.

The lamination layer is preferably bonded over the entire surface of the first or second surface of the decorative part. This means that the lamination layer covers the entire surface in the length and width direction of the decorative layer and leaves no gaps. This ensures that all areas of the decorative layer that may be separated from each other are cohesive via the lamination layer.

The lamination layer is preferably made of an electrically insulating material. The material is preferably such that it is not damaged, deformed or discolored as a result of the electrical discharge.

The material of the lamination layer is preferably translucent. The material may be completely transparent or only partially translucent. This is particularly important if the lamination layer is attached to the first surface of the decorative layer and this surface is to define the visible side of the decorative part. This ensures that the pattern on the first surface remains visible through the lamination layer.

However, the lamination layer may also be attached to the carrier side of the decorative part. This may be the case, for example, if the lamination layer is bonded to the first surface in accordance with the second variant of the method and the thickness of the decorative layer is selected such that the burned in-pattern is visible on the second surface. In this case, the first surface and the lamination layer attached thereto may define the carrier side of the decorative part, while the second surface defines the visible side. Similarly, a lamination layer attached to the second surface according to the first variant of the method may define the carrier side.

If the lamination layer is attached to the carrier side of the decorative part, it may consist of an opaque or translucent material. Preferably, it is also made of a translucent material in this case. This makes it possible to illuminate the decorative layer through the lamination layer.

The lamination layer can, for example, consist of fleeces, fabrics, fiber materials (e.g. paper) or plastic. The plastic used is preferably a polyimide or a polyimide-containing composition. The lamination layer preferably consists of a plastic film or a fabric or fleece on an inorganic basis, particularly preferably a polyimide-based plastic film or a glass fiber fleece. The plastic film may be manufactured before bonding with the decorative layer, for example by extrusion or injection molding, and then applied to the decorative layer. However, it is also possible to apply the plastic film directly to the surface of the decorative layer by injection molding, as described below.

In a preferred embodiment, the lamination layer consists of an injection-molded plastic. Preferably, a polyimide or a polyimide-containing composition is used for this purpose. The plastic may be applied directly to the relevant surface of the decorative layer via injection molding, for example. This has proven to be a particularly advantageous manufacturing method, as it enables the manufacturing of decorative parts with great precision and in large quantities. Applying the lamination layer by injection molding also has the advantage that the molten plastic applied penetrates into the indentations of the burned-in pattern and seals them. This enables greater mechanical reinforcement of the decorative layer and thus greater durability of the decorative part.

The plastic may be applied either to the second surface of the decorative layer in accordance with the first variant of the method or to the first surface of the decorative layer in accordance with the respective second variant of the method. Even when applied to the second surface, the plastic may seal the indentations of the burned-in pattern if the pattern is burned into the decorative layer to such a depth that openings are created towards the second surface and the plastic may flow through these openings.

In a preferred embodiment of the invention, the indentations of the burned-in pattern are filled with a sealing material after the pattern has been burned in. As described above, this may be the applied molten material of the lamination layer. However, an additional material may also be used for this purpose. The sealing material is preferably applied to the first surface of the decorative layer in an initially liquid form and then hardens. In the first variant of the method, the sealing material is applied to the first surface of the decorative layer after the decorative layer has been bonded to the lamination layer and after the pattern has been burned in. In the second variant of the method, the sealing material is applied after the pattern has been burned in but before the first surface is bonded to the lamination layer, provided that the sealing material is not the material of the lamination layer itself.

In particular, translucent resins or plastics may be used as sealing materials. Thermoplastic compositions that are filled into the indentations of the pattern in molten form and hardened by cooling are particularly suitable. Inorganic bonds, in particular cement-or ceramic-like substances, are also suitable as sealing materials. Metals that are applied in molten form may also be used. Tin, which is non-toxic to humans due to its relatively low melting point of 231° C., may be poured into the channels and solidify there. The sealing material may also contain additives and/or fillers, such as particles, fibers or pigments.

After applying the sealing material, further processing is preferably carried out, for example by grinding the first surface, so that the sealing material and the surface of the decorative layer are flush with each other.

The shape of the burned-in pattern may be influenced in particular by the voltage applied, the shape of the electrodes and the texture of the first surface.

In principle, direct or alternating current may be used for burning in the pattern. The voltage applied influences the shape of the pattern. For example, a higher voltage leads to deeper, wider patterns. A lower voltage, on the other hand, leads to a more branched, more filigree and less deep pattern.

Two or more electrodes are used for burning in the pattern. Preferably exactly two electrodes are used.

The electrodes used for burning in the pattern may have different shapes, resulting in differently shaped contact surfaces between the electrode and the surface of the decorative layer. For example, the contact surface between an electrode and the surface of the decorative layer may be punctiform or elongated. A punctiform contact area is an essentially circular or square area in which the ratio of length to width is approximately equal to 1. An elongated contact surface is an area in which the ratio of length to width is greater than 1, in particular greater than 2, greater than 5 or greater than 10. An elongated contact surface may, for example, have the shape of an elongated oval or rectangle.

The shape of the Lichtenberg-figure may be influenced by combining differently shaped contact surfaces. For example, if an electrode with a punctiform contact surface (a “punctiform electrode”) is combined with an electrode with an elongated contact surface (an “elongated electrode”), the pattern of the Lichtenberg-figure grows from the punctiform electrode towards the elongated electrode when the electrical voltage is applied. In this case, the elongated electrode is preferably arranged so that the longitudinal direction of the contact surface extends at a right angle to the connecting line between the two electrodes. If two punctiform electrodes are combined, the pattern grows from both electrodes in the direction of the other electrode in each case. Preferably, at least one of the electrodes used has a punctiform contact surface.

In order for a pattern to be burned into the surface of the decorative layer when an electrical voltage is applied, this surface must be electrically conductive. The electrically conductive properties may be influenced in particular by applying an electrolyte solution to the first surface. Preferably, salt solutions or other aqueous electrolyte solutions are used here. In a preferred embodiment, the first surface is wetted with an aqueous electrolyte solution before being brought into contact with the electrodes.

Following the method described above, the decorative part may be further processed. In particular, further layers may be bonded to the decorative part. For example, a translucent top layer may be applied to the visible side of the decorative part in order to protect the decorative layer from external influences, in particular mechanical stress and/or UV radiation. Furthermore, the carrier side of the decorative part may be bonded to a carrier layer.

In a preferred embodiment, after burning in the pattern and bonding it to the lamination layer, the decorative part is cut to remove the areas where the electrodes were placed on the decorative layer.

### Decorative Part

The invention also provides a decorative part. The decorative part comprises a decorative layer and is characterized in that the decorative layer has a first surface and a second surface facing away from the first surface; the decorative layer has a pattern created by an electrical discharge on the first surface; and the first or the second surface is bonded to a lamination layer.

The decorative part may be manufactured using the method described above.

The decorative part according to the invention is characterized in particular by a small thickness of the decorative layer. Preferably, the thickness of the decorative layer is 100 mm or less, 50 mm or less, 20 mm or less, 10 mm or less, 5 mm or less, or 2 mm or less. Preferably, the thickness is in a range of 0.1 mm to 100 mm, 0.5 mm to 50 mm, 1 mm to 20 mm, or 2 mm to 10 mm.

The decorative part according to the invention is, in particular, a decorative part for a vehicle interior. For example, the component may serve in this function as part of the interior trim of a vehicle interior. It may be used, for example, in motor vehicles, in particular cars and trucks, trains and airplanes. The decorative part is particularly suitable as part of the dashboard, the door trim or the roof trim of vehicle interiors. In addition, the component may also be used as wall cladding in buildings or as a component of furniture.

### BRIEF DESCRIPTION OF THE DRAWINGS

The present invention is explained in more detail below with reference to embodiments in relation to the following drawings. The drawings show:

FIG. 1: An example of a typical Lichtenberg-figure

FIG. 2: A schematic setup according to an embodiment of the method according to the invention

FIG. 3: A schematic setup according to a further embodiment of the method according to the invention

FIG. 4: A schematic setup according to FIG. 2 after applying the electrical voltage

FIG. 5: A schematic setup according to FIG. 3 after applying the electrical voltage

FIG. 6: A schematic plan view of a decorative part according to the invention

FIG. 7: A schematic perspective view of a decorative layer at an intermediate step of the second variant of the method according to the invention

FIG. 8: A cross section view of the decorative layer along line A:A in FIG. 7 at a further intermediate step of the second variant of the method according to the invention

### DETAILED DESCRIPTION OF THE PREFERRED EMBODIMENTS

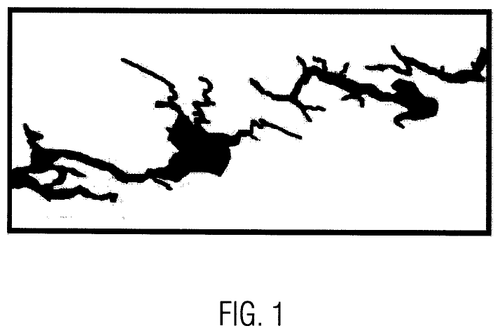

FIG. 1 shows an example of a typical Lichtenberg-figure. This corresponds to the pattern that may be obtained using the method according to the invention.

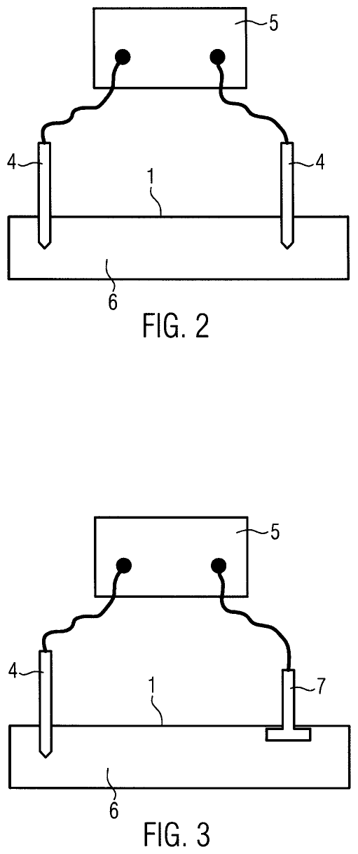

FIG. 2 shows a schematic setup for the method according to the invention. In this embodiment, a decorative layer 1 is brought into contact with two electrodes 4. In this embodiment, the decorative layer 1 consists of a wood veneer. The electrodes 4 are placed on the first surface 6 of the decorative layer 1. The second surface of the decorative layer 1 is not shown in this example. It is located on the side of the decorative layer 1 facing away from the viewer. In the embodiment shown, both electrodes 4 have a punctiform contact surface with the first surface 6. Both electrodes are electrically connected to a voltage source 5. In this embodiment, the first surface 6 was wetted with an aqueous electrolyte solution before the electrodes 4 were attached.

FIG. 3 shows a schematic setup according to a further embodiment of the method according to the invention. The setup corresponds to that of FIG. 2, but instead of one of the punctiform electrodes 4, an electrode 7 with an elongated contact surface is used.

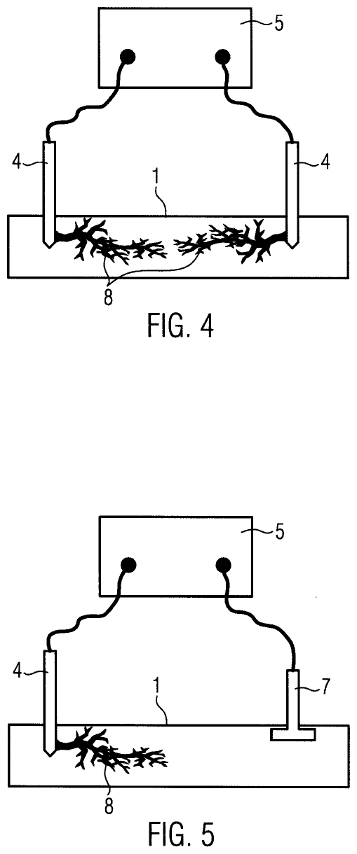

FIGS. 4 and 5 show the two embodiments according to FIGS. 2 and 3 after the application of an electrical voltage. FIG. 4 corresponds to the setup shown in FIG. 2, wherein two Lichtenberg-figures 8 have formed as a result of the electrical discharge, which extend from both electrodes 4 in the direction of the other electrode. FIG. 5 corresponds to the structure shown in FIG. 3. In this embodiment, only one Lichtenberg-figure has formed, which extends from the punctiform electrode to the elongated electrode.

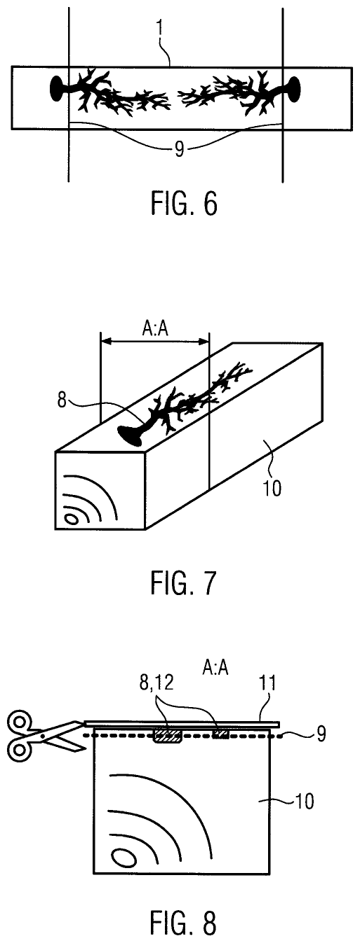

FIG. 6 shows a decorative part according to the invention in plan view of the first surface of the decorative layer 1, which is decorated with two Lichtenberg-figures. This decorative part may be obtained by the setup according to FIGS. 2 and 4. In this embodiment, the decorative part is cut along the separating lines 9 to remove the areas with the contact points of the two punctiform electrodes. The lamination layer is not shown in this embodiment. It may be bonded to either the first surface facing the viewer or the second surface facing away from the viewer.

FIGS. 7 and 8 illustrate the second variant of the manufacturing process according to the invention.

FIG. 7 shows a decorative layer 10 with a pattern 8 in the form of a burnt-in Lichtenberg-figure according to the second variant of the method according to the invention. In this case, the decorative layer 10 consists of a relatively thick wooden board. In this example, the thickness of the decorative layer 10 is selected such that the pattern 8 does not penetrate the entire thickness of the decorative layer 10.

FIG. 8 shows a cross-sectional view of the decorative layer 10 according to FIG. 7 along the plane A:A after the application of a sealing material 12 and the bonding of the first surface with a lamination layer 11. In this example, the indentations of the pattern 8 are filled with the sealing material 12. The lamination layer 11 is bonded to the first surface of the decorative layer 10. After bonding the lamination layer 11, the first decorative layer 10 is separated into two partial layers along the separating line 9, wherein the upper partial layer comprises the pattern 8, the sealing material 12 and the lamination layer 11. The upper partial layer may be made so thin that the indentations of the pattern 8 penetrate the entire thickness of the partial layer. The previously bonded lamination layer 11 ensures the mechanical stability of the partial layer and thus the quality of the pattern 8.

### LIST OF REFERENCE SIGNS

1, 10 Decorative layer

4 Electrode with punctiform contact surface

5 Voltage source

6 First surface

7 Electrode with elongated contact surface

8 Pattern

9 Separating line

11 Laminating layer

12 Sealing material

What is claimed is:

1. A method of manufacturing a decorative part comprising the steps of:
providing a decorative layer having a first, electrically conductive surface and a second surface facing away from the first surface;
bringing two or more electrodes into contact with the first surface;
applying an electrical voltage between the electrodes so that an electrical current flows between the electrodes and a pattern is burnt into the first surface; and
wherein the decorative layer is bonded to a lamination layer before the application of the electric voltage.

2. The method according to claim 1, wherein:
the decorative layer has a predetermined minimum thickness, and
wherein after the lamination layer has been bonded, the material of the decorative layer is removed from the second surface, so that the thickness of the decorative layer is reduced to a predetermined maximum thickness.

3. The method according to claim 2, wherein:
the predetermined maximum thickness of the decorative layer is selected such that the pattern becomes visible on the second surface.

4. The method according to claim 2, wherein:
the predetermined minimum thickness of the decorative layer is selected such that the burning in of the pattern does not result in any island-shaped areas which no longer have any mechanical cohesion with the rest of the decorative layer.

5. The method according to one of claims 1, wherein:
the lamination layer consists of an electrically insulating material.

6. The method according to claim 1, wherein:
the lamination layer consists of a translucent material.

7. The method according to claim 1, wherein:
the lamination layer consists of a plastic film or a fabric or fleece on an inorganic basis, preferably a polyimide-based plastic film or a glass fiber nonwoven.

8. The method according to claim 7, wherein:
the lamination layer is formed by injection-molding of a plastic.

9. The method according to claim 1, wherein:
a contact area between the first surface and a first electrode is punctiform and a contact area between the first surface and a second electrode is elongated.

10. The method according to one of claim 1, wherein:
the first surface is wetted with an aqueous electrolyte solution before being brought into contact with the electrodes.

11. A method of manufacturing a decorative part comprising the steps of:
providing a decorative layer having a first, electrically conductive surface and a second surface facing away from the first surface;
wetting the first surface with an aqueous electrolyte solution;
bringing two or more electrodes into contact with the first surface;
applying an electrical voltage between the electrodes so that an electrical current flows between the electrodes and a pattern is burnt into the first surface; and
wherein the decorative layer is bonded to a lamination layer before the application of the electric voltage.

12. The method according to one of claim 11, wherein:
the decorative layer has a predetermined minimum thickness and wherein after the lamination layer has been bonded, a material of the decorative layer is removed from the second surface, so that a thickness of the decorative layer is reduced to a predetermined maximum thickness.

13. The method according to claim 12, wherein:
the predetermined maximum thickness of the decorative layer is selected such that the pattern becomes visible on the second surface.

14. The method according to claim 12, wherein:
the predetermined minimum thickness of the decorative layer is selected such that burning in of the pattern does not result in any island-shaped areas which no longer have any mechanical cohesion with the rest of the decorative layer.

15. The method according to one of claims 11, wherein:
the lamination layer consists of an electrically insulating material and wherein the lamination layer consists of a translucent material.

16. The method according to claim 11, wherein:
the lamination layer consists of a plastic film or a fabric or fleece on an inorganic basis, preferably a polyimide-based plastic film or a glass fiber nonwoven.

17. The method according to claim 16, wherein:
the lamination layer is formed by injection-molding of a plastic.

18. The method according to claim 11, wherein:
the contact area between the first surface and a first electrode is punctiform and the contact area between the first surface and a second electrode is elongated.

19. A decorative part comprising a decorative layer, wherein
the decorative layer has a first surface and a second surface facing away from the first surface;
the decorative layer has a pattern on the first surface generated by an electrical discharge; and
the first surface or the second surface is bonded to a lamination layer.
